(19) United States
(12) Patent Application Publication
(10) Pub. No.: US 2006/0126444 A1
(43) Pub. Date: Jun. 15, 2006

(54) Watch for dispensing scents, vapor and/or droplets, and storage device

(76) Inventors: Brenda Ellner, Shaker Heights, OH (US); Paulette Nance, Moreland Hills, OH (US)

Correspondence Address: D. PETER HOCHBERG CO. L.P.A., 1940 EAST 6TH STREET, CLEVELAND, OH, 44114, US

(21) Appl. No.: 11/348,702

(22) Filed: Feb. 7, 2006

Related U.S. Application Data
(63) Continuation-in-part of application No. 10/448,886, filed on May 30, 2003.
(63) Continuation-in-part of application No. 09/630,056, filed on Aug. 1, 2000, now Pat. No. 6,618,328.
(63) Continuation-in-part of application No. PCT/US02/17063, filed on May 31, 2002.
(63) Continuation-in-part of application No. 11/202,281, filed on Aug. 11, 2005.
Application No. 11/202,281 is a continuation of application No. 10/655,716, filed on Sep. 6, 2003, now Pat. No. 6,940,785.
Application No. 10/655,716 is a division of application No. 09/630,056, filed on Aug. 1, 2000, now Pat. No. 6,618,328.
(60) Provisional application No. 60/384,243, filed on May 30, 2002.
(60) Provisional application No. 60/418,694, filed on Oct. 16, 2002.
(60) Provisional application No. 60/384,243, filed on May 30, 2002.

(51) Int. Cl. G04C 21/30; G04B 23/10; G04B 23/06

(52) U.S. Cl. 368/246

(57) ABSTRACT

A watch assembly having a back assembly, a timepiece and a door forming a compartment for holding a material for emitting scents, vapors or droplets, at least one of the timepiece and the door being movable relative to the back assembly for providing access to the compartment, and a passage or capillary means for transferring the scents, vapors or droplets to the ambient surroundings. The watch assembly can be replaced by a fob which need not include a timepiece. Also disclosed is a watch assembly or a fob for carrying the cremains of a person or pet having a door to a storage compartment which is permanently sealed once the cremains are in the compartment and the door is tightened in a closed position.

### CROSS-REFERENCE TO RELATED APPLICATIONS

This application is a continuation-in-part of U.S. application Ser. No. 10/448,886 filed May 30, 2003, which claims priority of U.S. provisional application Ser. No. 60/384,243 filed May 30, 2002 and Ser. No. 60/418,694 filed Oct. 16, 2002, is a continuation-in-part of U.S. application Ser. No. 09/630,056 filed Aug. 1, 2000 (now U.S. Pat. No. 6,618,328), is a continuation-in-part of International application No. PCT/US02/17063 filed May 31, 2002 which claims priority on U.S. Provisional application No. 60/384,243 filed May 30, 2002, is a continuation-in-part of U.S. application Ser. No. 11/202,281 filed Aug. 11, 2005, which is a continuation of U.S. application Ser. No. 10/655,716 (now U.S. Pat. No. 6,940,785) filed Sep. 6, 2003 which itself is a division of Ser. No. 09/630,056.

### BACKGROUND OF THE INVENTION

1. Field of the Invention

The present invention relates to watches, particularly but not limited to wristwatches having a timepiece, and a fob, each having an inner compartment for holding a material for emitting a scent, a vapor, droplets and the like, and an access to the compartment. The invention further relates to a watch or fob having a sealing compartment for holding such substances as cremains.

2. Description of the Prior Art

There are many different watches which are on the market or otherwise known for holding items in addition to timepieces. Some are described below.

U.S. Pat. No. 5,384,756 discloses a combined identification device and wristwatch. The watch face is hinged over a platform holding a microfilm with the wearer's medical information. If the watch face is lifted up, panels, which are biased upwardly, reveal the microfilm. The microfilm is carried in one of the panels, and another panel has a lens for focusing on the microfilm. The watch backing itself is only, in effect, a receptacle for holding the folded panels.

A modular watch having interchangeable elements is shown in U.S. Pat. No. 5,657,298. A rescue watch is described in U.S. Pat. No. 5,663,932 where the watch assembly has a container chamber holding pressurized liquid or gas to provide air for inflating a device or for spraying an assaulter when the rescue watch is used for self-defense.

A watch having a pivotable timepiece revealing a compartment for holding an object such as a cigar cutter is disclosed in U.S. Pat. No. 6,079,872. U.S. Pat. No. 6,002,651 discloses a wristwatch having a timepiece pivotal from a base or floor to make available a cosmetics tray with an applicator.

Various devices other than watches are known for emitting scents for both hunting purposes and for personal use. Scent dispensers for hunting are known from U.S. Pat. No. 4,735,010 (boot attachment), U.S. Pat. No. 6,857,579 (tree attachment), U.S. Pat. No. 6,102,301 (tree attachment), U.S. Pat. No. 4,374,571 (clothing or bush attachment) and U.S. Publication No. 2005/0199740 (tree attachment). Scent dispensers for personal use are known which are also not used with watches. These include U.S. Pat. No. 292,963 (finger ring), U.S. Pat. No. 1,780,408 (pin or clasp), U.S. Pat. No. 6,881,382 (electronic device attachment) and U.S. Publication No. 2004/0146435 (electronic device attachment).

Watches are known for dispensing scents, although the inventors are not aware of any for use by hunters. In U.S. Pat. No. 4,945,523, a watch assembly has a pair of spaced apart glasses defining a fluid-holding chamber, a ring for holding the glasses having a fluid-transmitting passage and an absorbent ring from which an aromatic scent is vaporized. U.S. Publication No. 2004/0113793 discloses a tracking device comprising a mechanism for dispensing scent or dye for generating a tracking signal due to the rise in body temperature or stress-sensing activator. The mechanism could be located on the face of a watch.

Other than the disclosures of the present inventors' earlier patents and patent applications, there are no known wristwatches having doors on the rear or back portion of a watch assembly for revealing a compartment for some functional member. There are no watch assemblies of any kind of which the present inventors are aware, and more significantly no watch assemblies having a door for revealing a compartment, that have been developed for hunters to be used for leaving scents to attract game and other animals. There are also no watch assemblies known to the inventors having either a timepiece removable from a back assembly or a removable back door for revealing a compartment for a material from which scents, vapor, droplets or the like, and structure for transmitting the desired scent.

The inventors are likewise unaware of any fob having the foregoing features or a sealable compartment for holding such substances as cremains.

### SUMMARY OF THE INVENTION

It is an object of the present invention to provide a watch assembly having a compartment for a scent-emitting object or material and a movable cover providing access to the compartment.

Another object is the provision of a wristwatch assembly having an inner compartment to which access can be had by one or both of a movable timepiece or door and configured to dispense a scent from a scent-emitting object in the compartment.

A still further object is the provision of a hunter's watch assembly for emitting scent to attract game and other animals.

It is another object to provide a hunter's watch assembly with a compartment for holding a scent-emitting object and structure for dispensing the scent from the compartment to the ambient surroundings.

It is still yet another object to provide a hunter's watch assembly having a compartment for holding a scent-emitting object and a door movable to open and close the compartment.

An additional object of the present invention is to provide a hunter's watch assembly with a compartment for holding a scent-emitting object, where access to the compartment can be had through one of a movable timepiece or a movable door.

Another object is the provision of a hunter's watch assembly having a compartment for holding a fluid absorbent material to which a scent-emitting fluid can be added for dispensing from the watch assembly.

Yet another object is the provision of a wristwatch assembly having an openable compartment for holding various scent-emitting objects, the scents being of various types other than those for attracting animals, such as those for pest repellents, including animals and insects; for use on the body, such as perfume; for hair; for various health treatments; for deodorants; for women's and men's fragrance; for rooms and gardens and the like.

It is still a further object to provide a watch assembly having an openable compartment with a discharge device for fluids having vapor or droplet emissions for various uses, the fluids not necessarily having scents of interest but other desired characteristics.

It is another object to provide a watch assembly for holding a scent or other characteristic-emitting object having an easy to load inner compartment, an easy to install object or material for a desired emission and an easy-to-use dispensing structure.

A general object is to provide a carrying device for holding an emitting object in a compartment of a portable container, which container could be but is not confined to be a watch assembly, and is herein characterized by the word “fob,” which is constructed to dispense a scent, vapors or droplets and the like.

Another object is to provide a fob for generating scents, such as for attracting animals, perfume or for driving away pests; vapors, such as for stage effects like smoke or fog; or droplets, such as for medicinal purposes like insulin spray for diabetics, hair spray and other sprays.

An additional object is to provide a watch assembly or fob and a compartment with a cover that can be permanently closed for holding such contents as cremains of a person or a pet.

These and other objects will be apparent to those skilled in the art from the description to follow and in the appended claims.

One form of the invention as described below in greater detail is a hunter's watch assembly having an inner compartment to which access can be had by a removable door on the back of the watch assembly and/or a movable timepiece, in which an appropriate scent-emitting object, such as gauze, is placed, and passages from the compartment extending through one or more portions of the watch assembly for dispensing scents from an appropriate fluid poured or otherwise situated on the object.

Another example of a preferred form of the invention for achieving some of the foregoing objects is a watch assembly having an accessible inner compartment for holding an aroma-emitting object such as a pad for aftershave lotion, perfume, various cosmetic and medicine or other healthcare products which can be dispensed from the compartment by appropriate passages extending from the compartment to the ambient environment.

According to another version of the invention, a wristwatch assembly has an inner compartment for holding a spray-type ingredient, such as insulin for use with inhalers, hair spray, throat spray and the like. The watch assembly has a gas passage from the outside of the watch assembly to the inner compartment and dispensing structure with an appropriate nozzle for dispensing the spray. The gas passage has a connection device to which an atomizer or other dispensing apparatus can be connected. This dispensing apparatus is used to generate an airflow through the compartment to create the spray as it flows through the nozzle to a desired target area.

It is another object of the invention to provide a watch assembly having an inner compartment for holding material to be applied on or inside a body, an auxiliary apparatus for dispensing the material or part thereof from the compartment and further apparatus for ducting the material or part thereof to a target area on or in a body.

The inventive concept also can be used with a fob having an interior compartment for holding a scent, vapor or droplet-emitting object. The fob is preferably portable and has outlet passages for dispensing vapors or droplets, the passages being of a size and configuration depending on the nature of the emission and its target. For those products being dispensed requiring dispensing apparatus, such as an atomizer, appropriate inlet passages and connection devices between the dispensing apparatus and the fob are provided as well. For some emission fluids, absorbent materials such as pads, gauze, cotton or artificial absorbent substances for holding the liquid can be used, while in other situations a liquid compartment is appropriate, and yet in other situations the container is configured to receive appropriate cartridges or vials holding the fluid.

### BRIEF DESCRIPTION OF THE DRAWINGS

The invention may take physical forms in certain parts and arrangement of parts, the preferred embodiment of which will be described in detail in the specification and illustrated in the accompanying drawings which form a part hereof, and wherein:

FIG. 1 is a front view of a watch assembly according to the invention.

FIG. 2 is a back view of a watch assembly according to the invention, mounted on a watchband.

FIG. 3 is a back view of the watch shown in FIG. 2 with a rear door in the open position.

FIG. 4 is a side view of the watch shown in FIG. 2 with a timepiece in an open position.

FIGS. 5 and 6 are detailed perspective views of part of the watch assembly shown in FIG. 2

FIG. 7 is an exploded, partial perspective view of details of the watch assembly shown in FIG. 2.

FIG. 8 is a perspective view of another embodiment of a watch assembly according to the invention, viewing the front part of the watch assembly.

FIG. 9 is a perspective view of the watch assembly shown in FIG. 8, viewing the rear portion of the watch assembly.

FIG. 10 is a perspective view of the watch assembly shown in FIG. 8 with a timepiece in an open position.

FIG. 11 is a perspective view of the watch shown in FIG. 8 with a rear door in a removed position.

FIG. 12 is a partial, exploded perspective view of a detail of the watch assembly shown in FIG. 8.

FIG. 13 is a front view of a watch assembly according to another embodiment of the present invention.

FIGS. 14, 15, 16 and 17 show all sides of the watch shown in FIG. 13.

FIGS. 18 and 19 are partially cross-sectional views of an embodiment of the invention showing the timepiece in its open and closed positions, respectively.

FIG. 20 shows another embodiment of the invention showing a watch assembly in perspective form having a removable pad in the backing of the watch.

FIG. 21 is a cross section of an atomizer for use with watch assemblies according to the invention.

FIG. 22 is a side view of a syringe for use with watch assemblies according to the invention.

FIG. 23 is a perspective view of an ampule for use with watch assemblies according to the invention.

FIG. 24 is a side view of an inhaler for use with watch assemblies according to the invention.

FIGS. 25 and 26 are perspective front and rear views of a watch assembly to another version of the invention having a door to a compartment in a permanently closed position.

FIG. 27 is a perspective view of the watch assembly shown in FIGS. 25 and 26 with the timepiece in an open position.

FIG. 28 shows the rear portion of the watch assembly of FIGS. 25 and 26 with the door in an open position.

### DESCRIPTION OF THE PREFERRED EMBODIMENTS

The invention involves a watch assembly having an inner compartment for holding material which can be dispensed, according to what is held in the compartment, such as a scent, a vapor or droplets. Access to the compartment can be accomplished by means of a movable back door or by means of a movable timepiece. The movable back door could be hinged to, be totally separated from, or be otherwise separable from the support member, back assembly or body member of the watch assembly, or by means of a timepiece which is similarly movable with respect to the support member, back assembly or body portion of the watch assembly. The compartment could hold a great variety of substances to be dispensed therefrom. It could emit a scent such as for deer or other game to attract them to the scented area, it could hold perfume, cologne, after shave lotion or the like, and other similar substances which could be soaked in a pad or other object disposed in the compartment and emitted through a appropriate passages from the watch assembly. In other instances, a liquid could be supplied by means of a container which could be the compartment itself, or by means of a vial or ampule which itself could be compressed to dispense its contents. Another use is for emitting droplets of fluid which could be effected by means of an atomizer or other airflow or pressure-changing device appropriately attached to the watch assembly for providing airflow across the contents of the compartment. Furthermore, it could be used for other medicinal purposes, such as to hold the contents for use with an inhaler which could be connected to the watch assembly and having a mouthpiece for withdrawing the contents of the compartment.

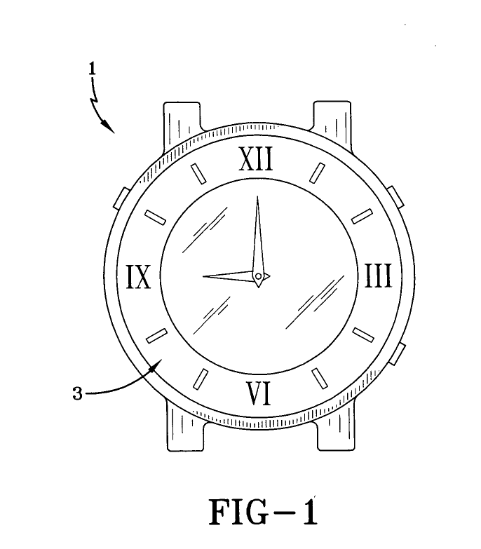

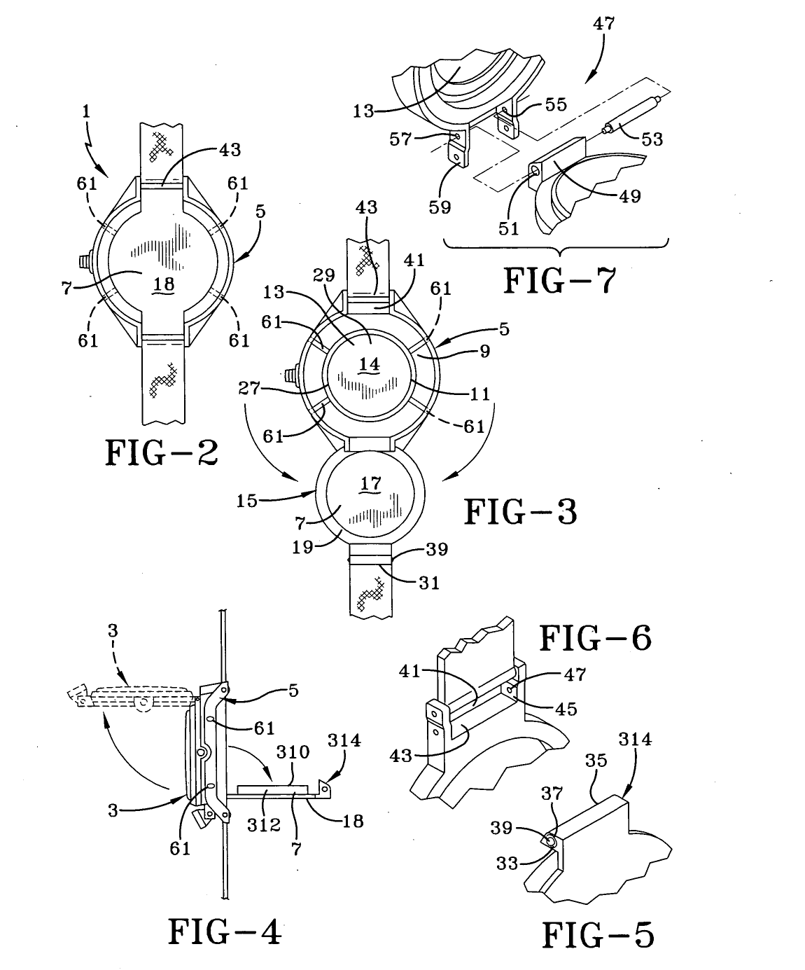

A first embodiment of the invention is shown in FIGS. 1-7. This embodiment shows a watch assembly 1 having a timepiece 3. Watch assembly 1 also has back assembly 5 comprising a pivotable backing or door 7 and a back rim 9. Pivotable backing 7 is depicted as pivotable downwardly relative to back assembly 5 when watch assembly 1 is held in an upright fashion. It should be appreciated that pivotable backing 7 can also be pivotable in an upward direction, in a sideways direction or in any other direction relative to back assembly 5. A ledge 11 extends inwardly from rim 9. Part of a compartment 13 is formed by the back surface 14 of timepiece 3 and the inner side surface of ledge 11 (mentioned below). Compartment 13 can hold a pad or other fluid-absorbable material, a container for holding an appropriate fluid, an ampule and the like, and may have to be configured according to the object which it holds. It is also possible that a disc or other partition could be held on ledge 11 to provide a base support for the object from which the scent, vapor or fluid droplets are to be contained. Pivotable backing 7 includes a base 15, a flat annular raised surface 17 and an annular sidewall 19, annular sidewall 19 extending from base 15 to surface 17. Surface 17 is configured to form compartment 13 when backing 7 is in the closed position, and compartment 13 holds whatever object is necessary to hold the fluid in watch compartment 13. Surface 17, when pivotable backing 7 is closed, fits snugly within the parameters of rim 9 and engages ledge 11. An outside surface 18 of timepiece 3 lies flat against the user's wrist so as not to be uncomfortable to the user when backing 7 is in its closed position. Ledge 11 has an inner sidewall 27 defining a small part of compartment 13. Ledge 11 has a forward wall which could support a partition 29, which could be transparent, and which could incorporate a microcircuit and the like.

Pivotable backing 7 also includes a pushpin housing 31 at one end of pivotable backing 7. In this instance, because pivotable backing 7 pivots downwardly relative to back assembly 5, housing 31 is located at the top of backing 7. It should be appreciated that the exact location of housing 31 on backing 7 will depend on the direction pivotable backing 7 opens. Housing 31 includes a cylindrical bore 33 therethrough, an upper surface 35 and a pin 37 which extends through bore 33. Each end of pin 37 holds a retractable ball bearing 39.

Back assembly 5 also comprises a pushpin housing compartment 41 comprising a compartment ledge 43 and opposing sidewalls 45. A mating hole 47 is located on each of opposing sidewalls 45. Retractable ball bearings 39 retract in order to allow housing 31 to be placed between sidewalls 45, and then ball bearings 39 return to normal position within corresponding mating holes 47. The securing of retractable ball bearings 39 with corresponding mating holes 47 locks or snaps pivotable backing 7 in a closed position relative to back assembly 5, thereby securing the object with the fluid within. When pivotable backing 5 is closed, housing 31 is secured within pushpin housing compartment 41. A space 43 remains above pushpin housing compartment 41, with space 41 being able to receive a tool for dislodging backing 7 from housing 31, thereby allowing backing 5 to be opened. In other words, when the watch wearer desires to gain access into back assembly 5, he or she inserts a tool, such as a coin, into space 43 to dislodge housing 31 from pushpin housing compartment 41.

Pivotable backing 7 further includes a pivot assembly 47 pivotably securing pivotable backing 7 at its end opposite that from pushpin housing 31 with back assembly 5. Referring to FIG. 7, pivot assembly 47 comprises a pin housing 49 having a hollow bore 51 therethrough for accommodating a pin 53. Pin 53 can be retractable, like pushpin 37 described above or can be non-retractable. Two additional oppositely placed holes 55 are provided on the inner portion of back face 13 which correspond to bore 51. Pin 53 extends through bore 51 and is secured into each of holes 57 on face 13. A second pin housing compartment 59, which is preferably similar in design to pushpin housing compartment 41 above, is provided on back assembly 5 within which pin housing 49 and pin assembly 47 may pivot. It should of course be appreciated that pivot assembly 47 described herein is but just one example of how backing 7 may be pivoted or rotated relative to back assembly 5 and any other comparable method may be used as well, such as a hinge assembly and the like.

In order for the scent, vapor or droplets to be dispensed from compartment 21, one or more passages 61 are provided. Passages 61 can be machined through back assembly 5 as shown. In some instances, such as with deer scent, these passages can be quite small, measuring about a millimeter in diameter, but they may have to be larger or smaller depending on the form of the substance to be dispensed through passages 61. As explained below, in some instances only one passage 61 is necessary whereas in others more than one passage is required. If back assembly 5 is made from metal, an appropriate machining operation, such as drilling, would be appropriate. In other cases, such as where back assembly 5 is made of plastic or sintered metal, an appropriate molding die would be appropriate.

As shown in FIGS. 1-7, both backing or back door 7 and timepiece 3 are movable with respect to back assembly 5 for revealing compartment 13. As mentioned, one possibility is to have the compartment be defined at its rearward end by backing 7, with either a partition 29 defining the upper portion of compartment 13 or the back of timepiece 3. In fact, timepiece 3 could be fixed and not movable if only backing 7 were to be the access compartment 13. Likewise, access to compartment 13 could be only by way of timepiece 3 when it is movable from back assembly 5. In this situation, no movable backing or back door is required.

As explained below, it may in some instances be necessary to use an auxiliary device with watch assembly 1 in which the auxiliary device is connected to compartment 13. In such situations, one of passages 61 could have an appropriate fitting for an input device to be used to send some material into compartment 13. Likewise, it might be necessary to have a passage 61, which is used to emit material from compartment 13 in a particular form, in which case one or more passages 61 could be constructed as a nozzle to increase the speed or the size of the material flowing from compartment 13 through passage 61.

Compartment 13 can be a secret compartment if desired. Due to the construction of watch assembly 1, compartment 13 need not be understood by those other than the wearer of watch assembly 1 that compartment 13 even exists. Thus, the existence of compartment 21 need not be known to anyone other than the wearer, thus making it a secret compartment. On the other hand, it may be advantageous for compartment 13 to be recognizable as such, such as where the compartment holds some medicinal substance for which the wearer of watch assembly 1 may need help in having the medicinal substance administered to the wearer.

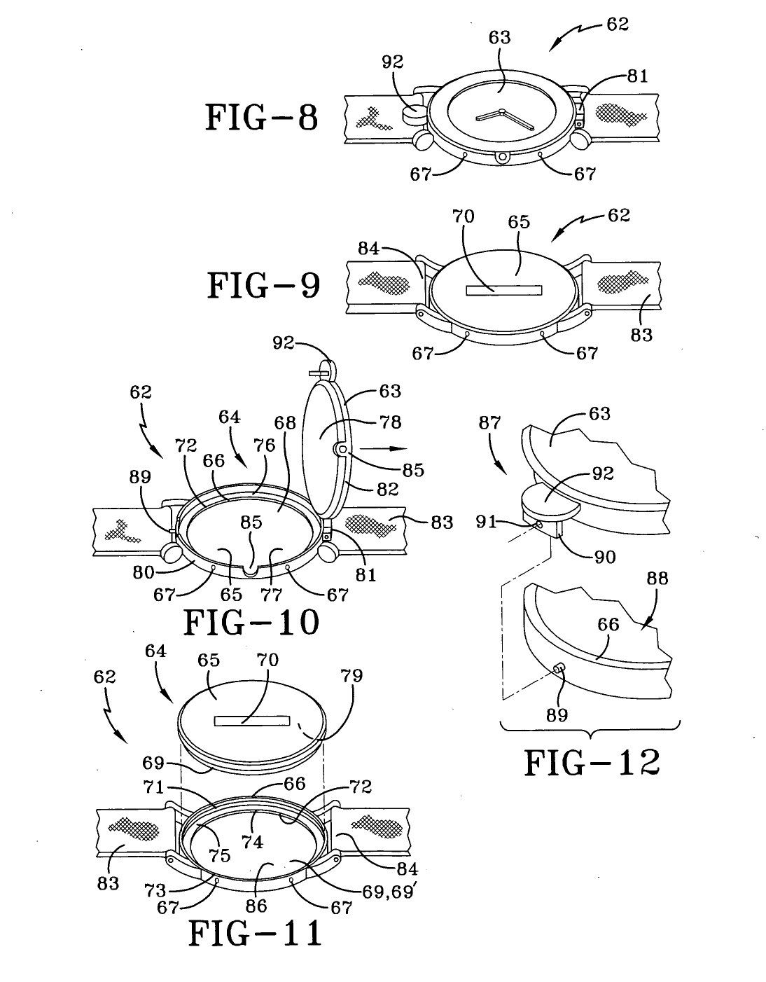

Referring to FIGS. 8-12, a watch assembly 62 is shown having a timepiece 63. Watch assembly 63 has a back assembly 64 comprising a removable backing or back door 65 and a back rim 66. Back door 65 includes external peripheral threads 69 and a slot 70 for receiving a coin or other turning device. Rim 66 has internal threads 71 for receiving threads 69 as backing 65 is screwed into back assembly 64. Threads 69 and 71 could be bayonet threads to minimize the turns required to remove and install back door 65. A ledge 72 extends inwardly from rim 66. A pad or other object relating to the material to be dispensed from watch assembly 62 after backing 65 is screwed into rim 66 with little or no clearance to prevent wobbling of the insert in the compartment while enabling backing 65 to be screwed in tightly in rim 66 as shown in FIG. 9. Ledge 72 has a lower seating face 75 against which back door 65 can engage when closed. Ledge 72 also has a forward face 76 to which can be attached a glass or plastic piece 77 which can act as a partition between a forward and a rearward compartment 68, 69 when timepiece 63 and back door 65 are closed, respectively. Forward compartment 68 could hold a picture or any other article, and rearward compartment 69 would hold a material to be dispensed. Alternatively, piece 77 may be omitted in watch assemblies to be used to increase the size of a single compartment 69 for the foregoing material. The forward or outer surface of a compartment is defined in part by a back 78 of timepiece 63. Back 78 can be blank or hold some inscription on it. Timepiece 63 can be rotated 180° to make it easier for an engraver to place such inscriptions on the timepiece. The rearward or inner surface of the compartment 69 (or of the only compartment if only one exists) is the forward or inner surface 79 of back door 65. A set of passages 67 extends through a sidewall 80 of back assembly 64 to connect compartment 69 with the ambient surroundings. Scents, vapors or droplets from the material in the compartment flow through passages 67.

Timepiece 63 is connected to the balance of watch assembly 62 by means of a hinge 81 of any appropriate type. Hinge 81 has compartments on both sidewall 80 and on a rim 82 of timepiece 63, which are preferably located in line with a band 83 or with the holding members 84 for the band. A notch 85 is provided inside wall 80 for receiving a manual wind, or setting, or control button when timepiece 63 is in the closed position. Hinge 81 is preferably of a type which enables timepiece 63 to remain at whatever angle it is opened to rather than being biased to an open or closed position, although the latter art is within the scope of the invention.

An appropriate device should be incorporated to latch the timepiece in a locked position in order to protect the timepiece and the watch assembly, as well as to maintain the secrecy of the compartment(s) if such is desired. (There is one compartment 68 between inside surface 78 of timepiece 63 and glass or plastic piece 77, and rearward compartment 69 between piece 77 and back 79 of back door 65. Of course, if piece 77 is omitted as explained above, there is just one compartment 69′.) A locking device 87 that has been found to be particularly beneficial is a retractable pin assembly 88 having a retractable pin 89 biased outwardly from rim 66, and a flange 90 extending from a graspable or finger-engageable knob 92 extending from timepiece 63. Flange 90 has a bore 91 for receiving pin 89 to keep timepiece 63 in a locked position. A wearer of watch assembly 62 can grasp with knob 92 his or her fingers to rotate timepiece 63 about hinge 81, and in so doing having the edge of flange 90 around bore 91 retract pin 89. In order to close timepiece 63, the reverse action is taken. Knob 92 can carry a logo of a school, organization or the like, an advertising message, the name of an organization, the name, abbreviation or initials of the wearer, the contents of the compartment, and perhaps some indication of any medical condition of the wearer of the watch, and the like.

Watch assembly 62 is a very effective unit. It looks and operates as a conventional watch. The material for being dispensed from the watch can be easily inserted into compartment 69 or 69′, and if the watch assembly is so configured, photographs and the like can be inserted or removed from second compartment 68 if one is available. It should be appreciated that timepiece 63 can alternatively be opened towards the user or in either sideways directions wherein hinge 81 is moved to either side of watch assembly 62.

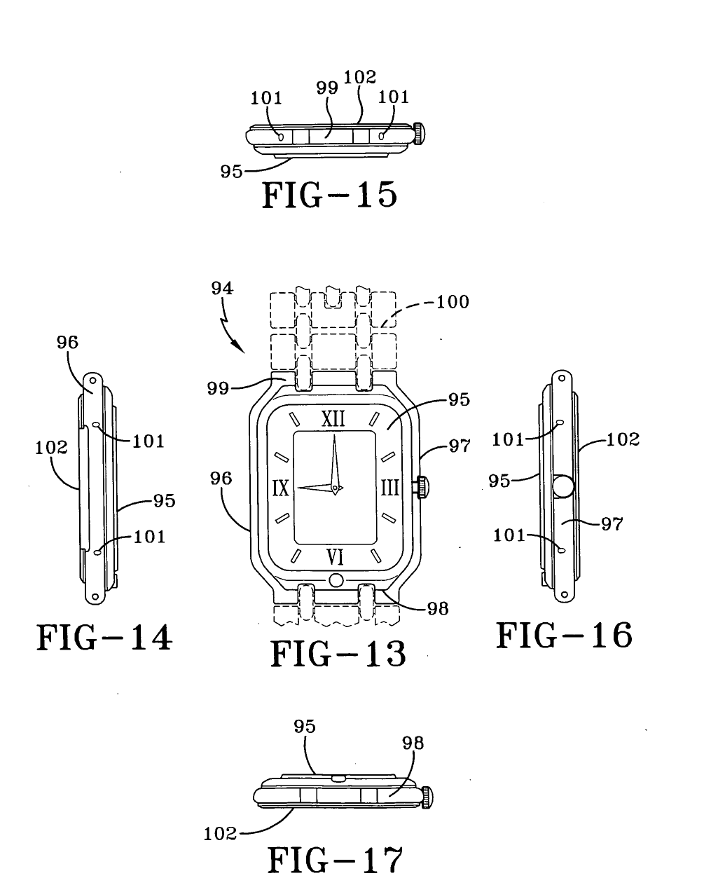

FIGS. 13-17 show a watch assembly 94 according to the invention, which can look like an ordinary watch, be it round, oval, square, rectangular (as shown) or other symmetrical or irregular shapes, which need not reveal that it has a secret compartment for holding the substances described above. Watch assembly 91 has a timepiece 95 that is held in a casing or back assembly having a left sidewall 96, a right sidewall 97, a first wall 98 and an opposite second wall 99. A watchband 100 is connected by an appropriate mechanism at walls 98 and 99. Walls 96-99 form on their outside portion the walls of the backing which holds the emitting object from which the scent, vapor or droplets come from. A series of passages 101, corresponding to passages 67 in FIGS. 1-12, are provided. The description of passages 101 is the same as that for passages 67 discussed previously. Timepiece 95 can be mounted for pivotal movement to reveal the compartment beneath the timepiece, and a backing or back door 102 can be removable, such as by being hinged for pivotal movement or removable from the back assembly.

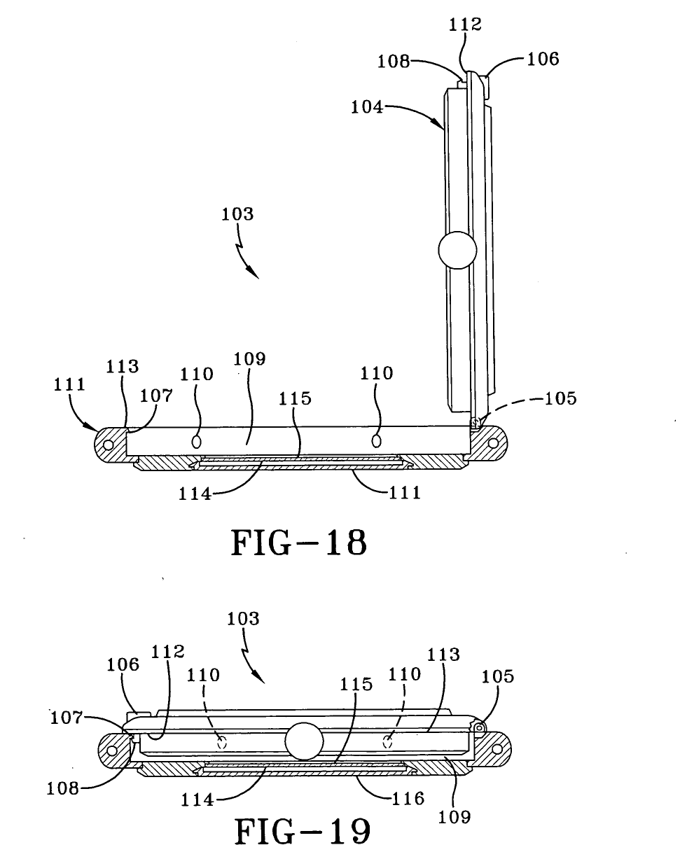

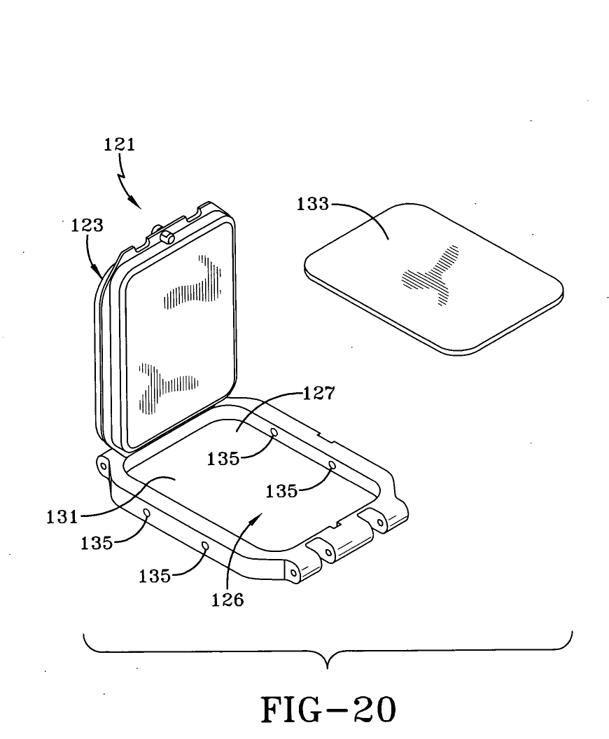

A similar embodiment of the invention is shown in FIGS. 18 and 19. These figures show a watch assembly 103 having a timepiece 104 which is pivotable about a hinge 105 and held in place in the closed position as shown in FIG. 19 by means of a latch assembly composed of a manually operable latch release 106 which cooperates with a locking tooth 107. Timepiece 104 is pivoted about hinge 105 from the open position shown in FIG. 18 to the closed position shown in FIG. 19. A finger 108 connected to latch release 196 engages locking tooth 107 to releasably hold the latch in its locked position. When latch release 106 is depressed or slid to one side according to the details of the latch assembly, timepiece 104 can be moved to the open position. A spring can be provided to bias timepiece 104 to its open position.

Watch assembly 103 has a compartment 109 to which access can be had when timepiece 93 is in its open position as shown in FIG. 18. A pad can be placed in compartment 109 and appropriate fluid contents can be poured on the pad for emission through a set of passages 10S.

Timepiece 103 is shown having a size slightly smaller than the cross dimensions of a back assembly 111 on which timepiece 104 is hinged. Timepiece 104 has a peripheral lip 112 for engaging a corresponding lip 113 on back assembly 111 to close compartment 109 when timepiece 104 is in the closed position. This expands the size of compartment 109 since it extends around the side portions of timepiece 104, wherefore passages 110 can be located in the middle part of the sidewalls of back assembly 110 to increase their strength and make them easier to be constructed.

Another compartment 114 is provided beneath a partition 115 separating compartments 109 and 114. A door 116 can be open to give access to compartment 114. Compartment 114 could be a message compartment and could include, for example, a picture or the like. Furthermore, compartment 114 could be of sufficient size to incorporate some tool for use with the contents of compartment 109. The tool could be some implement for adding fluid to compartment 109 or a pad disposed therein and could be a storage for pads for insertion into compartment 109. Furthermore, the configuration and purposes of compartments 109 and 114 could be reversed; that is, compartment 114 could hold the substance from which the scent, vapors or droplets are generated and compartment 109 could have some other purpose, such as a storage for pads or the like. In this case, compartment 114 would probably be larger than compartment 109, and passages 110 would be provided for giving access to compartment 114 rather than 109.

Another embodiment of the present invention is shown in FIG. 20. In this embodiment, a watch assembly 121 is shown having a timepiece 123 which is hinged on a wall of a back assembly or support assembly 126. Back assembly 126 includes a compartment 127 in which a removable pad 131 on which a fluid can be poured for emitting a scent (as for a hunter's watch, or perfume and the like for an individual, etc.). Pad 131 is held in an inner compartment 127 which is defined as a compartment when timepiece 123 is in the closed position. It should be noted that timepiece 123 could be opened 180° to enable an engraver to put an inscription on the back of timepiece 123 and also to enable a watchmaker to clean or repair timepiece 123.

Pad 127 is shown in compartment 129 and it preferably has the same shape as the compartment to keep its surface fairly uniform. A substitute pad 133 can be used to replace pad 127.

A set of passages 135 extends through back assembly 125 for emitting scents, vapors or droplets which are emitted from pad 131. As explained earlier, it may be that some auxiliary device, such as an atomizer, may be required to dispense material from compartment 126 through passages 135. One of the passages may therefore have an appropriate fitting so that the auxiliary device can be secured to watch assembly 121 in a sealed manner so that air and the like can be transmitted across compartment 126. Furthermore, it may be that a compressible ampule may be inserted inside of compartment 126, and the surface of watch assembly 121 facing timepiece 123 when it is in the closed position could be flexible so that it could be squeezed to compress the ampule and force its contents into compartment 126 to be dispensed from watch assembly 121. Similarly, if a device for adding material to compartment 126, when timepiece 123 is in the closed position, could be provided by means of a connection at one of passages 135 for enabling a filling device, such as a syringe, to add material to the compartment 126.

While FIG. 20 shows that timepiece 123 is pivotable, timepiece 123 could also be removable in other ways to reveal compartment 126. Also, a back door could be provided for giving access to compartment 126, and timepiece 123 need not be movable at all.

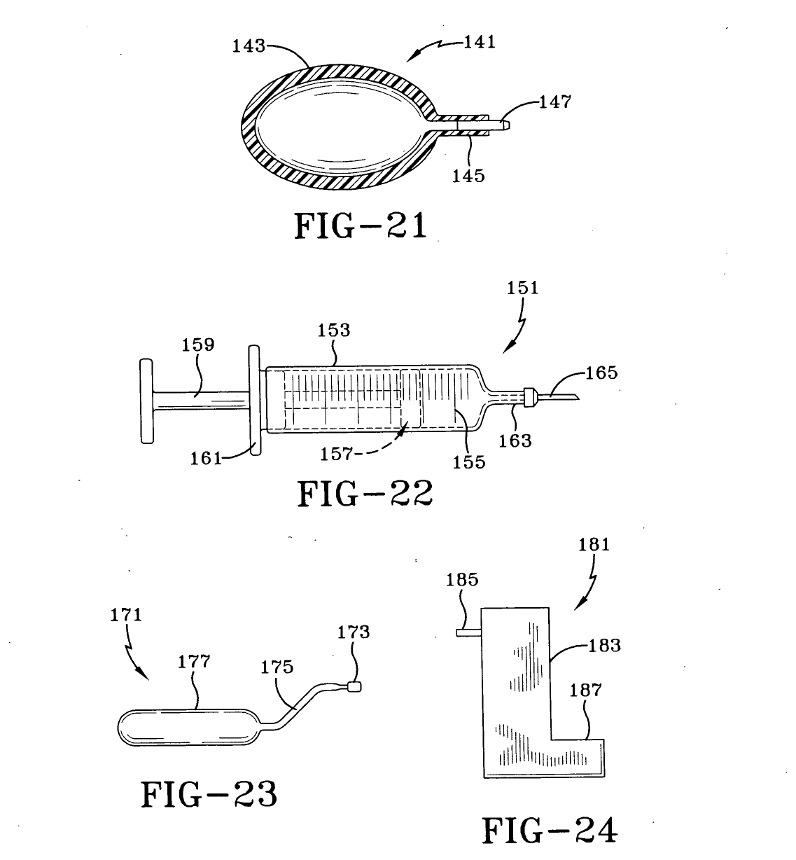

As mentioned earlier, the watch assembly according to the invention could be used with auxiliary devices. Appropriate connection structure would have to be provided for use with the auxiliary devices, such as those discussed below, and this connection structure is known in the art. If air pressure is required to emit a discharge from the inventive watch assembly, an atomizer 141 can be used as shown schematically in FIG. 21. Atomizer 141 has a both manually-compressible bulb 143, a discharge conduit 145 and a connection device 147 which can be connected to an appropriately configured passageway in the inventive watch assembly for forcing air or other fluid into the appropriate compartment of the inventive watch assembly. Atomizer 141 could be used for medicinal purposes, such as a nasal spray, for appearance purposes such as for hair spray, or any other similar use.

There are many types of filling devices which could be used for filling the compartment in the inventive watch assembly. One of the many such devices available is a syringe 151 as shown in FIG. 22. Syringe 151 has an outer cylinder 153 with appropriate capacity scale marks 155, a plunger assembly 157, a compressible handle 159 for moving the piston assembly in cylinder 153, a finger support bar 161 which is held by the user as the thumb compresses handle 159, and a dispensing port 163. Dispensing port 163 has a connecting structure 165 which can be inserted in an appropriately configured passageway in the inventive watch assembly for adding material to the compartment of the inventive watch assembly. The material is used for emitting scents, vapors or droplets from the watch assembly.

One way to put the material in the compartment of the inventive watch assembly which is to be dispensed from the watch assembly is by way of a prefilled ampule, vial, cartridge or capsule. Referring to FIG. 23, a compressible ampule 171 is shown. Ampule 171 is made of a compressible plastic and has a releasable closure device 173 at the end of a stem 175. The material itself is initially held in a bulb 177 of ampule 171. Once ampule 177 is placed in the compartment of the inventive watch, pressure is applied to the ampule to force the discharge of material from it. One way of accomplishing this is by having the rear portion of the watch assembly incorporate a compressible wall, which could be the wall of a back door. Such a compressible wall could be made of an appropriate plastic. Another way of accomplishing this is by having the back portion of the watch assembly be mounted so that it is compressible against the timepiece. This can be accomplished by having a compressible gasket or O-ring which holds the back portion of the watch assembly apart but which is compressed upon manual pressure put on the back piece to compress the ampule and discharge the material.

There are many types of medicinal uses to which a watch assembly according to the invention can be used. For example, and as mentioned earlier, an inhaler could be used with the contents of the compartment of the inventive watch. An inhaler 181 is shown in FIG. 24. Inhaler 181 has a closed wall 183 defining an interior chamber, and a connection stem 185 which can be inserted into an appropriately-configured passageway into the compartment of the inventive watch assembly. The material could be one of many different types, such as insulin. One needing insulin and having the watch assembly according to the invention could insert stem 185 into an appropriately-configured connection structure in the wall defining the compartment of the inventive watch assembly. Once the insulin material is contained in the compartment of the watch assembly, stem 185 is inserted into the appropriate passageway, and the user puts the user's mouth on mouthpiece 187. The user then withdraws the insulin material from mouthpiece 187.

The compartment of the inventive watch assembly may in some instances require additional material. For example, if there is any chance of a chemical reaction between the contents of the compartment of the inventive watch assembly, an appropriate liner should be used. This could be an appropriate plastic that is configured to line the compartment (while still allowing the material to exit therefrom), a non-reactive coating for the compartment, and the like.

Some materials which could be stored in the compartment according to the inventive watch assembly may lose their effectiveness or otherwise react or degrade in response to the temperature of the person wearing the watch assembly. For such situations, an appropriate temperature insulator could be installed on the back of the watch assembly to thermally insulate the watch assembly from the wearer of it.

The dispensing of scents, vapors and droplets from the compartment can be done through passages as explained earlier. However, in some instances it may be more appropriate to use such capillary medium as sponges, wick material and the like. The passages shown in the figures could be such capillary media.

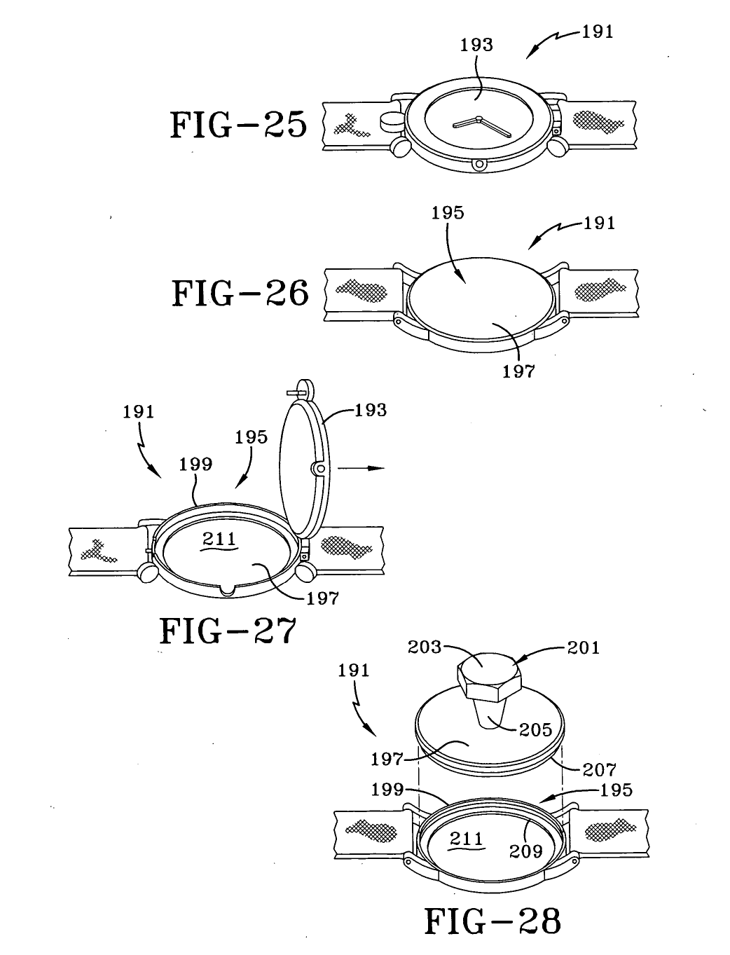

A variation of the invention discussed thus far is shown in FIGS. 25-28, which is similar in some respects to the invention described with respect to FIGS. 8-12. However, the latter inventive concept does not involve dispensing anything from the watch assembly. These figures show a watch housing 191 having a movable timepiece 193 and a back assembly 195 having a removable backing or back door 197 in a back rim 199. Back door 197 is constructed so that it cannot be opened once it is tightened in place. Back door 197 has a break-away bolt 201 as shown in FIG. 28. Break-away bolt 201 has a head 203, which is shown as being hexagonal, and a tapered stem 205. Back door 197 has a set of threads 207 which can engage threads 209 in back assembly 195 to hold back door 197 in place. A partition 211, which could be transparent, extends across back assembly 125. When back door 197 is screwed in place by means of the engagement of break-away bolt 201 and bolt 201 is screwed to its limit, break-away bolt 201 snaps off from door 197 as shown in FIG. 26. Therefore, once the door is tightened in place, it cannot be reopened.

The watch assembly shown in FIGS. 25-28 is a type of container which could be used to carry part of the cremains of deceased person or pet. A picture of the person or pet could be placed adjacent partition 139. A person's desire for keeping a lost loved one or pet in close contact could be fulfilled by wearing the watch assembly shown in FIGS. 25-28 on the person's wrist with a picture of the person or pet readily available. Break-away bolts are disclosed, for example, in U.S. Pat. Nos. 5,228,205 and 5,713,705, as well as in U.K. Patent Application 2140523. Although the break-away bolt is one means of securing the back door in a non-removable fashion, other means exist as well. These could include adhesives, break-away threads, welding and the like.

While the embodiments discussed hereinabove relate to watch assemblies, the inventive concepts could apply to other portable devices which are referred to herein as fobs. Fobs need not incorporate timepieces. They could be carry-around devices having no purpose other than dispensing scents, vapors or droplets, or for carrying the cremains a deceased person or pet with a picture or other remembrance of the person or pet. The fob could have other devices in addition to, or in place of, a timepiece. For example, the fob could have some sort of an electronic device for playing music, etc.; it could be a telecommunications device, such as a mobile cell phone; it could be a small camera, or for performing any of a large variety of functions.

The invention is described in detail with particular reference to the preferred embodiments thereof, but variations and modifications within the spirit and scope of the invention may occur to those skilled in the art to which this invention pertains.

We claim:

1. A watch assembly for dispensing scent, vapor or droplets, said watch assembly comprising:
a timepiece;
a backing disposed opposite said timepiece;
a back assembly for supporting said timepiece and said backing;
a compartment disposed at least partly in said back assembly between said timepiece and said backing, for holding a material for emitting the scent, vapor or droplet; and
at least one passage through said back assembly for transferring the scent, vapor or droplets from said compartment to the ambient surroundings.

2. A watch assembly according to claim 1 wherein said timepiece is removably mounted on said back assembly.

3. A watch assembly according to claim 2 wherein said timepiece is movable between a closed condition for forming said compartment, and an open condition for providing access to said compartment.

4. A watch assembly according to claim 3 wherein said timepiece is pivotably mounted on said back assembly for movement between the closed condition and the open condition.

5. A watch assembly according to claim 1 wherein said backing is removably mounted on said back assembly.

6. A watch assembly according to claim 4 wherein said backing is movable between a closed condition for forming said compartment, and an open condition for providing access to said compartment.

7. A watch assembly according to claim 6 wherein said backing is pivotably mounted on said back assembly for movement between the closed condition and the open position.

8. A watch assembly according to claim 6 wherein said backing is disconnected from said back assembly when said backing is in the open condition.

9. A watch assembly according to claim 8 wherein said backing has a cylindrical peripheral portion with threads and said backing assembly has corresponding threads for receiving said backing in a screwed-in condition.

10. A watch assembly according to claim 9 wherein said backing has a configured outer region for receiving a tool to turn said backing in said corresponding threads in said back assembly.

11. A watch assembly according to claim 1 wherein said back assembly forms part of said compartment, and said at least one passage extends through said back assembly.

12. A watch assembly according to claim 1 wherein each of said timepiece and said backing are movable away from and towards said back assembly to give access to said compartment.

13. A watch assembly according to claim 1 wherein each of said timepiece and said backing are movable away from said back assembly, and wherein said watch assembly further comprises a partition extending across said back assembly to establish a forward compartment and a rearward compartment, said at least one passage going to the at least one compartment for receiving the material for emitting the scent, vapor or droplets.

14. A watch assembly for dispensing scent, vapor or droplets, said watch assembly comprising:
a timepiece;
a backing disposed opposite said timepiece,
a compartment disposed between said backing and said timepiece; and
an open passage from said compartment to the ambient surroundings.

15. A watch assembly according to claim 1 wherein said compartment is configured to receive a pad onto which pad the material for emitting the scent, vapor or droplets is dispersed.

16. A watch assembly according to claim 15 and further comprising a second compartment for storing the pads.

17. A watch assembly according to claim 1 and further comprising an inlet passage into said compartment for connection to a device for forcing scents, vapors or droplets from the material out of said compartment.

18. A watch assembly according to claim 17 wherein the device is an air-forcing device for forcing air across said compartment and having an outlet end, and wherein said inlet passage is structured to operatively engage the outlet end of said air-forcing device.

19. A watch assembly according to claim 18 wherein the air-forcing device is an atomizer having an outlet port with a connector, and wherein said inlet passage has an inlet connector configured to operatively engage the connector of the atomizer.

20. A watch assembly according to claim 1 wherein said watch assembly further comprises an inlet passage to said compartment for operative connection to an input device for transferring material to said compartment through said inlet passage.

21. A watch assembly according to claim 20 wherein said inlet passage has an inlet connector for operative engagement with a discharge port of a syringe holding material to be transferred to said compartment.

22. A watch assembly according to claim 1 wherein said compartment is configured to receive a collapsible ampule filled with a material to be put in said compartment, and structure for opening said ampule to release the material into said compartment.

23. A watch assembly according to claim 22 wherein structure for forming said compartment can transfer compressing force on said compartment to effect the discharge of material from the ampule into said compartment.

24. A watch assembly according to claim 1 wherein said compartment is configured to hold an inhalable material, and wherein said at least one passage is configured to operatively engage an inlet port of an inhaler for discharging scents, vapors or droplets through the inlet port to be inhaled by a person using the inhaler.

25. A hunter's watch comprising:
a back assembly having sidewalls, front surfaces and opposing rear surfaces, said sidewalls having inside surfaces defining an open center region;
a timepiece pivotally attached to said back assembly and being movable between a closed position wherein said timepiece engages said front surfaces and an open position wherein said timepiece disengages said front surfaces;
a rear door pivotally attached to said back assembly and being movable between a closed position wherein said rear door engages said rear surfaces and an open position wherein said timepiece disengages said rear surfaces;
a compartment defined by said timepiece when said timepiece is in the closed position, by said rear door when said rear door is in the closed position, and the inside surfaces of said back assembly; and
at least one passage extending through said sidewalls of said back assembly between said compartment and the ambient surroundings.

26. A watch assembly for holding the cremains of a person or a pet, said watch assembly comprising:
a timepiece;
a backing disposed opposite said timepiece;
a back assembly for supporting said timepiece and said backing, at least one of said timepiece and said backing being movable between closed position(s) and open position(s), and having a fully-closed position; and
a compartment disposed at least partly on said back assembly between said timepiece and said backing when said timepiece and said backing are in their respective closed positions, said compartment being capable of receiving cremains when the movable one(s) of said backing and said timepiece are in an open position;
structure for disabling the movable of said backing and said timepiece when said movable one(s) of said backing and said timepiece are in the fully-closed position, to enable the storing of the cremains of a person or a pet in said compartment rendering access to said compartment impossible.

27. A watch assembly according to claim 26 and further including structure for supporting a picture of the person or pet whose cremains are in said compartment.

28. A watch assembly for holding the cremains of a person or a pet, said watch assembly comprising:
a back assembly having sidewalls with inner surfaces defining an opening in said back, assembly, said back assembly comprising front peripheral surfaces surrounding the forward portion of said back assembly and rear peripheral surfaces surrounding the rear portion of said back assembly;
support structure in said opening for supporting a picture of the person or pet whose cremains are to be stored or stored in said watched assembly;
a rear door movable between an open position and a fully-closed position for engaging the rear peripheral surfaces of said back assembly, said rear door defining part of a compartment in said watch assembly and incorporating part of said opening, structure for maintaining said rear door in the fully-closed position to permanently retain the cremains in said compartment; and
a timepiece movable between an open position wherein the picture in said support structure is viewable, and a closed position engaging the front peripheral surfaces of said back assembly.

29. A watch assembly for dispensing scent, vapor or droplets, said watch assembly comprising:
a timepiece;
a backing disposed opposite said timepiece;
a back assembly for supporting said timepiece and said backing;
a compartment disposed at least partly in said back assembly between said timepiece and said backing, for holding a material for emitting the scent, vapor or droplet; and
capillary medium extending through selected one(s) of said timepiece, said backing and said back assembly, said back assembly for transferring the scent, vapor or droplets from said compartment to the ambient surroundings.

30. A fob for dispensing scent, vapor or droplets, said fob comprising:
a forward member;
a rearward member disposed opposite said forward member;
a back assembly for supporting said forward member and said rearward member;
a compartment disposed at least partly in said back assembly between said forward member and said rearward member, for holding a material for emitting the scent, vapor or droplet, at least one of said forward member and said rearward member being movable with respect to said back assembly between a closed condition and an open condition, access to said compartment being provided when in the open condition; and
at least one passage through said back assembly for transferring the scent, vapor or droplets from said compartment to the ambient surroundings.

31. A fob according to claim 30 wherein said at least one of said forward member and rearward member is disconnected from said back assembly when said at least one of said forward member and said rearward member is in the open condition

32. A fob according to claim 30 wherein each of said forward member and said rearward member are movable away from said back assembly, and wherein said fob further comprises a partition extending across said back assembly to establish a forward compartment and a rearward compartment, said at least one passage going to the at least one compartment for receiving the material for emitting the scent, vapor or droplets.

33. A fob for dispensing scent, vapor or droplets, said fob comprising:
a forward member;
a rearward member disposed opposite said forward member;
a compartment disposed between said forward member and said rearward member; and
an outlet passage from said compartment to the ambient surroundings.

34. A fob according to claim 30 and further comprising an inlet passage into said compartment, said inlet passage having a connection for connection to said compartment and out said outlet passage.

35. A watch assembly according to claim 30 wherein said compartment is configured to hold an inhalable material, and wherein said at least one passage is configured to operatively engage an inlet port of an inhaler for discharging scents, vapors or droplets through the inlet port to be inhaled by a person using the inhaler.

36. A hunter's fob comprising:
a back assembly having sidewalls, front surfaces and opposing rear surfaces, said sidewalls having inside surfaces defining an open center region;
a first member pivotally attached to said back assembly and being movable between a closed position wherein said first member engages said front surfaces and an open position wherein said first member disengages said front surfaces;
a second member pivotally attached to said back assembly and being movable between a closed position wherein said second member engages said rear surfaces and an open position wherein said second member disengages said rear surfaces;
a compartment defined by said forward member when said forward member is in the closed position, by said second member when said second member is in the closed position, and the inside surfaces of said back assembly; and
at lease one passage extending through said sidewalls of said back assembly between said compartment and the ambient surroundings.

37. A hunter's fob comprising:
a back assembly having sidewalls, front surfaces and opposing rear surfaces, said sidewalls having inside surfaces defining an open center region;
a first member pivotally attached to said back assembly and being movable between a closed position wherein said first member engages said front surfaces and an open position wherein said first member disengages said front surfaces;
a second member pivotally attached to said back assembly and being movable between a closed position wherein said second member engages said rear surfaces and an open position wherein said second member disengages said rear surfaces;
a compartment defined by said forward member when said forward member is in the closed position, by said second member when said second member is in the closed position, and the inside surfaces of said back assembly; and
at least one medium extending through said sidewalls of said back assembly between said compartment and the ambient surroundings for transferring the scent from said compartment to the ambient surroundings.

38. A fob for holding the cremains of a person or a pet, said fob comprising:
a first member;
a second member disposed opposite said first member;
a supporting assembly for supporting said first member and said second member, at least one of said first member and said second member being movable between closed position(s) and open position(s), and having a fully-closed position; and
a compartment disposed at least partly in said supporting assembly between said first member and said second member when said first member and said second member are in their respective closed positions, said compartment being capable of receiving cremains when the movable one(s) of said first member and said second member are in an open position;
structure for disabling the movable one(s) of said first member and said second member when said movable one(s) of said first member and said second member are in the fully-closed position, to enable the storing of the cremains of a person or a pet in said compartment rendering access to said compartment impossible.

39. A fob according to claim 38 and further including structure for supporting a picture of the person or pet whose cremains are in said compartment.
